(19) United States
(12) Patent Application Publication
(10) Pub. No.: US 2012/0049719 A1
(43) Pub. Date: Mar. 1, 2012

(54) Spark Plug

(76) Inventor: Huei-Yuan Wu, Taichung County (TW)

(21) Appl. No.: 12/872,496

(22) Filed: Aug. 31, 2010

(51) Int. Cl. H01T 13/02

(52) U.S. Cl. 313/120

(57) ABSTRACT

A spark plug comprises a main body including a sparking terminal which is an end of the main body, a center electrode disposed at a center portion of the main body, and an earth electrode installed on an external circular wall at the sparking terminal, and having an extended end extended to a position corresponding to the center electrode, an air guide hole in the shape of a sandglass and formed on the extended end of the earth electrode, and a chamfer formed on the wall of the earth electrode. With the design of the air guide hole, the mixed petroleum and air are collected in an engine, and the design of a chamfer formed on the earth electrode improves the smoothness degree of the earth electrode significantly.

### BACKGROUND OF THE INVENTION

1. Field of the Invention

The present invention relates to a spark plug, and more particularly to an ignition component applied in an engine combustion chamber.

2. Description of the Related Art

Spark plug is generally used in cars and motorcycles that have a combustion engine, and the spark plug used as an ignition device bases on the principle of producing a spark by an electric discharge to combust a fuel, and the spark plug is usually installed on a wall at the top of a combustion chamber of an engine, and the ignition structure of the spark plug comprises a center electrode protruded from an end of the spark plug, and an earth electrode curvedly extended from a position with a gap from the center electrode, such that an electric discharge between these two electrodes can produce a spark to serve as an ignition mechanism.

However, the earth electrode of the conventional spark plug is designed with a curved long metal plate, and extended from and covered onto a side of an end of the spark plug. Although a gap can be maintained from the center electrode, the distribution of the mixed petroleum and air contained in the combustion chamber to the center electrode is affected adversely by the long metal plate, so that the petroleum and air can only be spread sideway towards the center electrode, and such design definitely affects the ignition efficiency of the spark plug. Furthermore, most earth plates come with a square shape, so that if the injection of the sparks is blocked after the ignition takes place, drawbacks such as incomplete combustion and carbon accumulation may arise.

Although conventional spark plugs as disclosed in Taiwan Pat. No. M359142 entitled “Improved structure of spark plug” and Taiwan Pat. No. M351542 entitled “Spark plug” include a slot or an equivalent structure formed on the earth electrode, yet such design still cannot overcome the drawbacks including a slow speed of collecting petroleum and air and an interference of injecting sparks after the ignition takes place. In view of the aforementioned drawbacks of the prior art, the inventor of the present invention designed a spark plug with an improved earth electrode, in hope of overcoming the drawbacks of the prior art.

### SUMMARY OF THE INVENTION

In view of the aforementioned shortcomings of the prior art, it is a primary objective of the invention to provide an innovative spark plug to overcome the shortcomings and deficiencies of the prior art.

To achieve the foregoing objectives, the present invention provides a spark plug, comprising:

a main body, having an end which is a sparking terminal, a metal thread section disposed on an external circular wall of the sparking terminal, and a center electrode disposed at a center portion of the sparking terminal; and

an earth electrode, being a long curved metal plate extended from the external circular wall at the sparking terminal, and having an extended end extended to a position corresponding to the center electrode of the main body, and an ignition gap being maintained from the center electrode, and an air guide hole formed on the wall of the extended end of the earth electrode and disposed at a position corresponding to the center electrode, and upper and lower ends of the air guide hole being tapered from the outside to the inside of the earth electrode to form a conical shape.

With the design of the special shaped air guide hole and the concave the earth electrode, the mixed petroleum and air in the combustion space of the engine can be collected between the center electrode and the earth electrode quickly to improve the ignition efficiency. In addition, the design of the chamfer disposed on the earth electrode provides the earth electrode with a smooth design for reducing the hindrance of injecting sparks after the ignition takes place, as well as reducing the occurrence of incomplete combustions.

### BRIEF DESCRIPTION OF THE DRAWINGS

FIG. 1 is a perspective view of a spark plug of the present invention;

FIG. 2 is a perspective view of a portion of a spark plug of the present invention; and

FIG. 3 is a cross-sectional view of a portion of a spark plug of the present invention.

### DETAILED DESCRIPTION OF THE PREFERRED EMBODIMENTS

The technical characteristics, contents, advantages and effects of the present invention will become apparent with the detailed description of preferred embodiments and the illustration of related drawings as follows. It is noteworthy to point out that the drawings are provided for the purpose of illustrating the present invention, but not necessarily drawn with the actual scale for a precise installation for the embodiments, and thus the scale and installation relation as shown in the figure are not intended for limiting the scope of the present invention.

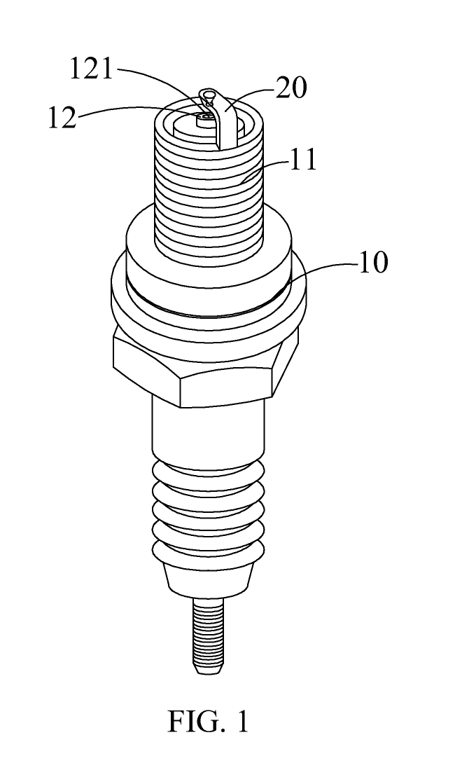

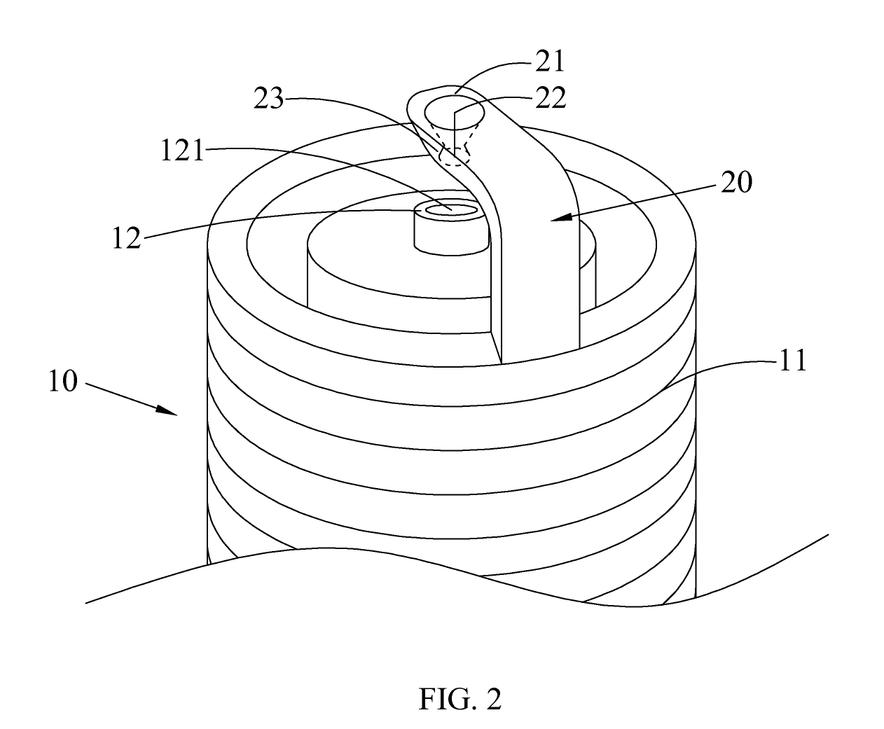

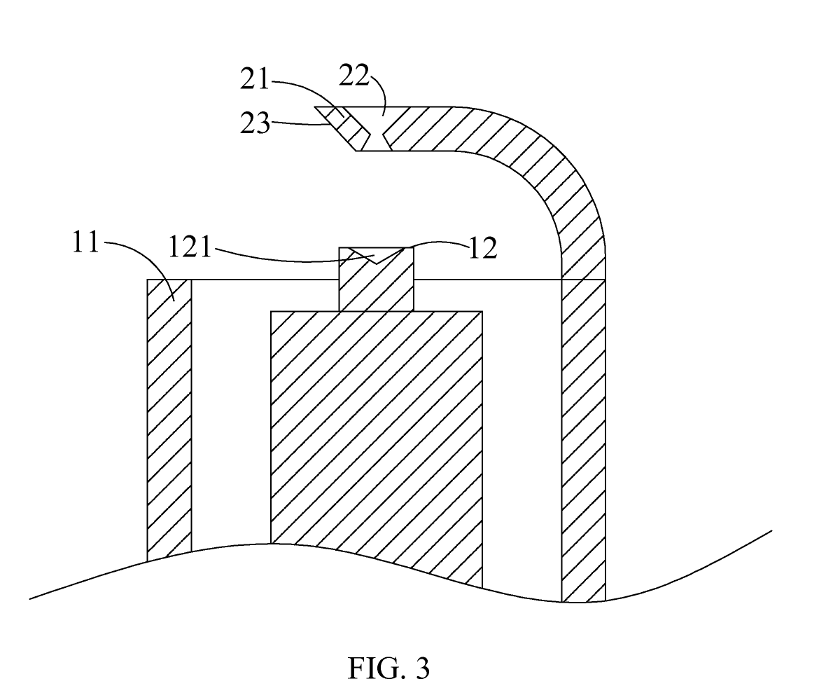

With reference to FIGS. 1 to 3 for a spark plug in accordance with a preferred embodiment of the present invention, the spark plug comprises a main body 10 and an earth electrode 20.

The main body 10 is a spark plug having a sparking terminal 11 at an end. A metal thread section is disposed on an external circular wall of the sparking terminal 11. A center electrode 12 is disposed at a center portion of the sparking terminal 11. In addition, a combustion supporting slot 121 is concavely formed on an upper surface of the center electrode 12 for improving the efficiency for supporting combustion.

The earth electrode 20 includes a curved long metal plate extended from the external circular wall at the sparking terminal 11. In addition, an extended end 21 of the earth electrode 20 extends to a position corresponding to the center electrode 12 of the main body 10 and the extended end 21 has a sparking gap maintained from the center electrode 12. An air guide hole 22 penetrates through the wall of the extended end 21 of the earth electrode 20 and disposes at a position corresponding to the center electrode 12, wherein the air guide hole 22 is in the shape of an asymmetric sandglass and includes upper and lower ends, which are tapered from the outside to the inside of the earth electrode 20 to form a conical shape respectively, and the earth electrode 20 includes a chamfer 23 formed respectively on both sidewalls of the earth electrode 20 in a circular arc shape or a slanted shape substantially, wherein the chamfer 23 has an outer diameter widened from the inside to the outside of the earth electrode 20.

With the structural design of the spark plug of the present invention, the sandglass-shaped design of the air guide hole 22 allows the mixed petroleum and air in the combustion space of the engine to be collected between the center electrode 12 and the earth electrode 20 quickly for the ignition, and the concave combustion supporting slot 121 further facilitates the collection of the mixed petroleum and air. In addition, the chamfer 23 disposed on the earth electrode 20 provides the earth electrode 20 with a smooth design for reducing the hindrance of injecting the sparks after the ignition takes place, as well as reducing the occurrence of incomplete combustions.

In summation of the description above, the present invention can improve over the prior art and comply with the patent application requirements, and thus is duly filed for patent application.

While the invention has been described by device of specific embodiments, numerous modifications and variations could be made thereto by those generally skilled in the art without departing from the scope and spirit of the invention set forth in the claims.

What is claimed is:

1. A spark plug, comprising:
a main body, having an end which is a sparking terminal, a metal thread section disposed on an external circular wall of the sparking terminal, and a center electrode disposed at a center portion of the sparking terminal; and
an earth electrode, being a long curved metal plate extended from an external circular wall at the sparking terminal, and having an extended end extended to a position corresponding to the center electrode of the main body, an ignition gap maintained from the center electrode, and an air guide hole formed on a wall of the extended end of the earth electrode and disposed at a position corresponding to the center electrode, wherein an upper end and a lower end of the air guide hole are tapered from the outside to the inside of the earth electrode to form a conical shape respectively.

2. The spark plug of claim 1, wherein the earth electrode includes a chamfer formed respectively on both sidewalls of the earth electrode and the chamfer has an outer diameter widened from the inside to the outside of the earth electrode.

3. The spark plug of claim 2, wherein the chamfer of the earth electrode is substantially in a circular arc shape.

4. The spark plug of claim 1, wherein the center electrode includes a combustion supporting slot concavely formed at an upper surface of the center electrode.
